(19) United States
(12) Patent Application Publication
(10) Pub. No.: US 2026/0081864 A1
(43) Pub. Date: Mar. 19, 2026

(54) NF REROUTING CONTROL IN TELECOMMUNICATIONS NETWORKS

(71) Applicant: DISH Wireless L.L.C., Englewood, CO (US)

(72) Inventors: Arjun Sarath, Highlands Ranch, CO (US); Ravi Madhavan, Naperville, IL (US); Kenneth William Weber, JR., Littleton, CO (US); Mohammad Dawood Shahdad, Aurora, CO (US)

(21) Appl. No.: 18/886,658

(22) Filed: Sep. 16, 2024

(51) Int. Cl. H04L 45/28; H04W 40/20

(52) U.S. Cl. CPC H04L 45/28; H04W 40/20

(57) ABSTRACT

Systems and methods of managing network function routing perform or comprise determining that a first network node has been rendered inoperable, wherein the first network node is associated with a first Session Management Function (SMF); retrieving a list of tracking area codes (TACs), the list of TACs corresponding to one or more network components serviced by the first network node via a second network node, wherein the second network node is associated with an Access and Mobility Management Function (AMF); transmitting the list of TACs to a third network node, wherein the third network node is associated with a second SMF; and causing the second network node to clear its cache.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications network to control notification flow to subscribed network functions.

According to one aspect of the present disclosure, a method of managing network function routing is provided. The method comprises determining that a first network node has been rendered inoperable, wherein the first network node is associated with a first Session Management Function (SMF); retrieving a list of tracking area codes (TACs), the list of TACs corresponding to one or more network components serviced by the first network node via a second network node, wherein the second network node is associated with an Access and Mobility Management Function (AMF); transmitting the list of TACs to a third network node, wherein the third network node is associated with a second SMF; and causing the second network node to clear its cache.

According to another aspect of the present disclosure, a telecommunications network is provided. The network comprises at least one processor in communication with a network management node; and a memory storing instructions that, when executed by the at least one processor, cause the network management node to: determine that a first network node has been rendered inoperable, wherein the first network node is associated with a first Session Management Function (SMF), retrieve a list of tracking area codes (TACs), the list of TACs corresponding to one or more network components serviced by the first network node via a second network node, wherein the second network node is associated with an Access and Mobility Management Function (AMF), transmit the list of TACs to a third network node, wherein the third network node is associated with a second SMF, and cause the second network node to clear its cache.

According to another aspect of the present disclosure, a non-transitory computer-readable medium is provided. The non-transitory computer-readable medium stores instructions that, when executed by at least one processor of a network management node in a telecommunications network, cause the network management node to perform operations comprising determining that a first network node has been rendered inoperable, wherein the first network node is associated with a first Session Management Function (SMF); retrieving a list of tracking area codes (TACs), the list of TACs corresponding to one or more network components serviced by the first network node via a second network node, wherein the second network node is associated with an Access and Mobility Management Function (AMF); transmitting the list of TACs to a third network node, wherein the third network node is associated with a second SMF; and causing the second network node to clear its cache.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3A illustrates an example of an NF routing configuration, in accordance with various aspects of the present disclosure.

FIG. 3B illustrates an example of an NF routing configuration, in accordance with various aspects of the present disclosure.

FIG. 3C illustrates an example of an NF routing configuration, in accordance with various aspects of the present disclosure.

FIG. 4A illustrates an example of an NF routing management method in accordance with various aspects of the present disclosure.

FIG. 4B illustrates an example of an NF routing management method in accordance with various aspects of the present disclosure.

FIG. 5 illustrates an example of an NF routing management system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

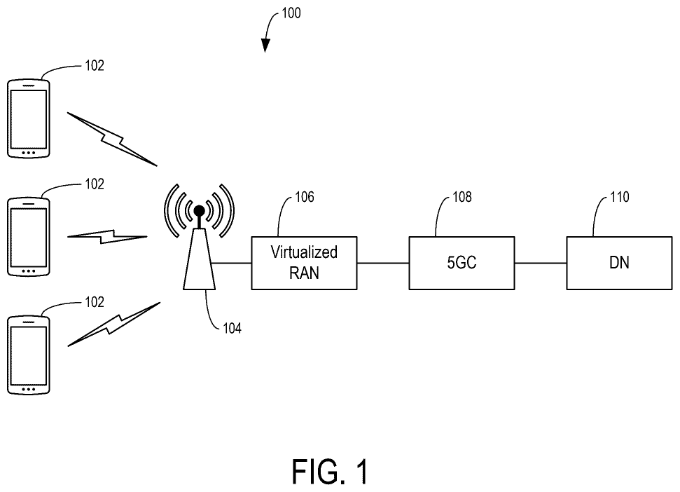

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

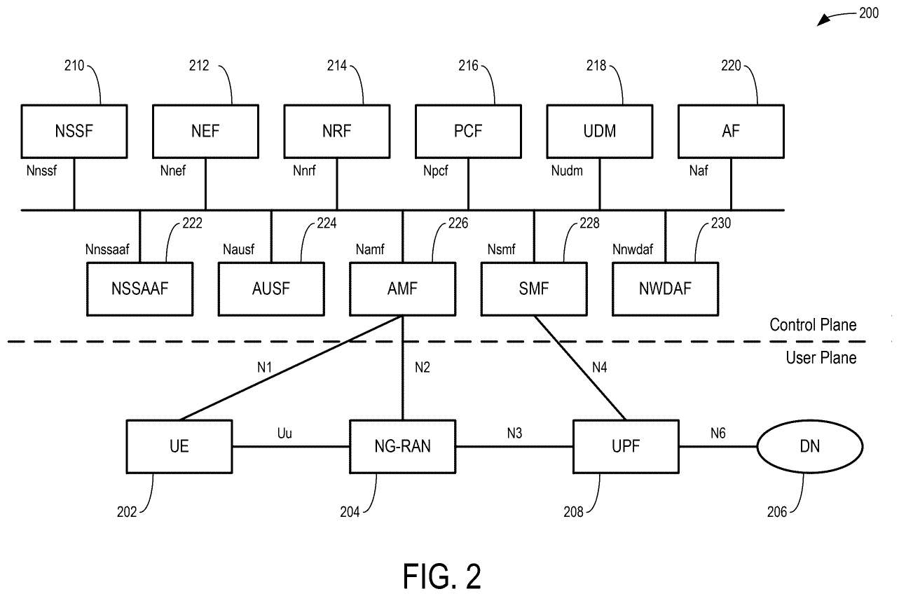

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For ease of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230. The orchestration domain includes an Element Management System (EMS) 232.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. While not illustrated in FIG. 2, the SBA 200 may include an N11 interface between the AMF 226 and the SMF 228.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement an instance of each of the above-described NFs with the exception of the SMF 228. Instead, the computing nodes may be configured to implement two separate instances of the SMF 228, each physically located in different data centers within the geographical region.

In such implementations, a first instance of the SMF 228 may provide services for a first geographical portion of the geographical region (e.g., the northern portion of the western United States) and a second instance of the SMF 228 may provide services for a second geographical portion of the geographical region (e.g., the southern portion of the western United States). The network may apportion connections among the two instances of the SMF 228 using tracking area code (TAC) based mapping. A TAC is an octet string used to indicate a geographical location and to identify one or more RAN sites. In TAC-based mapping, communications are routed through the SBA 200 based on the TAC, and the two instances of the SMF 228 serve independent TACs. The network may maintain a list of TACs and associate each TAC in the list with a corresponding instance of the SMF 228. For example, the list of TACs may associate a first subset of the TACs with RAN sites located in the first geographical portion of the geographical region, and thus route communications involving these RAN sites to the first instance of the SMF 228; and may associate a second subset of the TACs with RAN sites located in the second geographical portion of the geographical region, and thus route communication involving these RAN sites to the second instance of the SMF 228. In some examples, the list may be maintained in the NRF 214. Additionally or alternatively, sections of the list may be maintained in the appropriate instance of the SMF 228, such that the first instance of the SMF 228 includes a partial list identifying those TACs associated with the first instance of the SMF 228 and the second instance of the SMF 228 includes a partial list identifying those TACs associated with the second instance of the SMF 228.

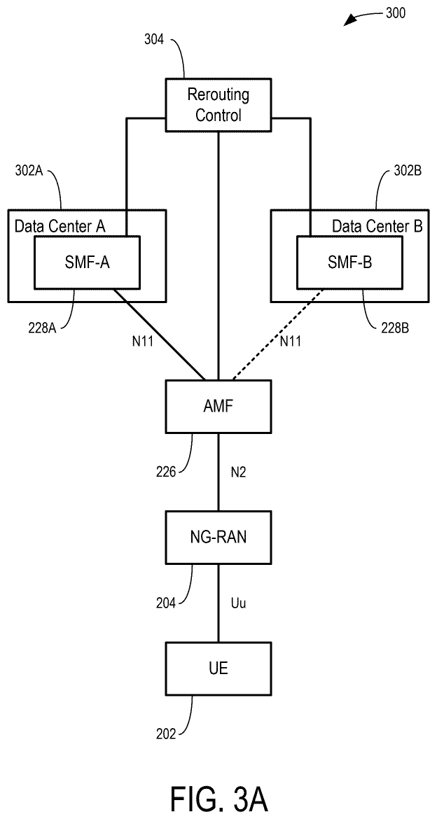

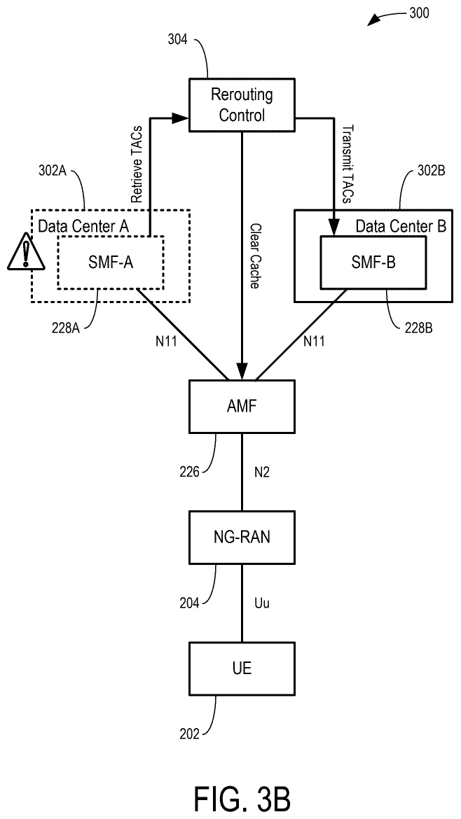

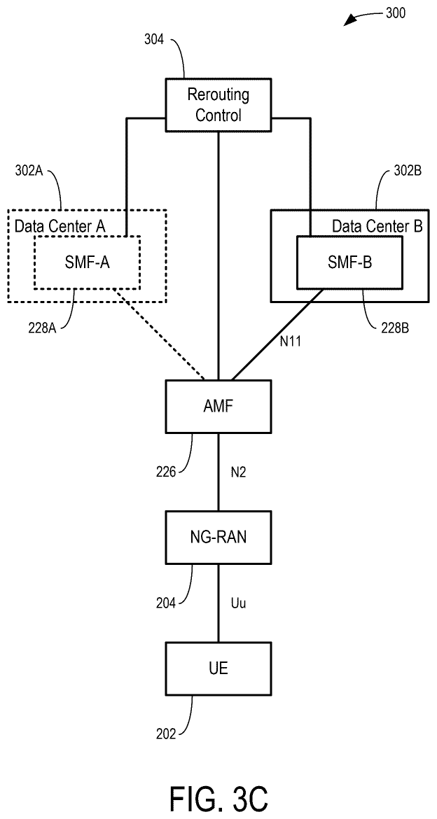

FIG. 3A illustrates a portion of the SBA 200 within a particular geographical region for a network 300. For ease of explanation, only one UE 202 is shown and several of the above described NFs are omitted. In practical implementations, many more UEs 202 may be present. FIG. 3A shows a UE 202 connected to an NG-RAN 204 (an example of a RAN site as described above), which is in turn connected to an AMF 226. The AMF 226 is connected to two different SMF instances via two different N11 interfaces. As illustrated, the AMF 226 is connected to a first SMF instance 228A, which physically resides in a first data center 302A, via a first N11 link; and is connected to a second SMF instance 228B, which physically resides in a second data center 302B, via a second N11 link. The NG-RAN 204 is associated with a TAC corresponding to the first instance 228A, and so the AMF 226 routes communications from the NG-RAN 204 to the first instance 228A via the first N11 link and the second N11 link is inactive (as shown by the dotted line in FIG. 3A).

In comparative examples, if an issue occurs with the first SMF instance 228A, all of the TACs associated with the first SMF instance 228A are affected and the comparative network operator is unable to shift traffic to the second SMF instance 228B. For example, if a disaster strikes the first data center 302A (e.g., a fire, an earthquake, a hurricane, an explosion, a power outage, etc.) and renders the first SMF instance 228A inoperable, the comparative network has no way of rerouting communications to maintain service to the UEs 202 connected to those NG-RANs 204 associated with the first subset of TACs. There exists a need for systems, methods, and media capable of rerouting traffic such that TACs previously served by the first SMF instance 228A may be instead served by the second SMF instance 228B.

Thus, the network 300 according to the present disclosure further includes a rerouting control mechanism 304 operatively connected to the first SMF instance 228A, the second SMF instance 228B, and the AMF 226. The rerouting control mechanism 304 may be embodied in the form of hardware, software, or a combination thereof. In one example, the rerouting control mechanism 304 may be embodied in the form of a script running on (or capable of being run on) a network management node (e.g., a control terminal). The script may execute in a cloud-based manner and provide control of physical computing nodes implementing the NFs. In some examples the rerouting control mechanism 304 may be operator-initiated (e.g., manually executed by a network operator), whereas in other examples the rerouting control mechanism 304 may be automated (e.g., automatically executed without runtime network operator input).

The disaster case scenario, and the effects of the rerouting control mechanism 304, are illustrated in FIG. 3B. In the situation illustrated in FIG. 3B, a disaster case scenario has occurred and affected the first data center 302A. As a result, the processing node implementing the first SMF instance 228A has been rendered inoperable. Because the second data center 302B is not collocated with the first data center 302A, the second SMF instance 228B is not affected by the disaster. In this scenario, the rerouting control mechanism 304 initiates a script that performs a series of operations to read all of the TACs corresponding to the first SMF instance 228A and distribute the TACs to the second SMF instance 228B. While FIG. 3B illustrates the rerouting control mechanism 304 reading the TACs from the first SMF instance 228A, this is merely for purposes of explanation. In examples, the rerouting control mechanism 304 may read the TACs from another NF (e.g., the NRF 214 and/or the AMF 226) in case the rerouting control mechanism 304 is unable to communicate with the first SMF instance 228A. When this copying happens, the rerouting control mechanism 304 instructs the AMF 226 to clear its cache. This causes the AMF 226 to query the NRF 214 for the most recent TAC routing allocation. The NRF 214 then informs the AMF 226 that the second SMF instance 228B is the proper target for the TACs that were previously (i.e., prior to the script) allocated to the first SMF instance 228A. Thereby, the first SMF instance 228A is taken out of the network 300. This is illustrated in FIG. 3C.

The rerouting control mechanism 304 may further be configured to revert to the original TAC routing scheme once the disaster case scenario has been remedied. For example, once the processing node implementing the first SMF instance 228A has been repaired or replaced, the rerouting control mechanism 304 may initiate the script a second time (or may initiate a second script) that performs a series of operations to read the TACs originally corresponding to the first SMF instance 228A, clear them from the second SMF instance 228B, and distribute them to the first SMF instance 228A. Then, the rerouting control mechanism 304 may again instruct the AMF 226 to clear its cache, which again causes the AMF 226 to query the NRF 214 for the most recent TAC routing allocation. The NRF 214 informs the AMF 226 that the first SMF instance 228A is the proper target for the TACs that were initially (i.e., prior to the disaster) allocated to the first SMF instance 228A. Thereby, the first SMF instance 228A is reintroduced to the network 300.

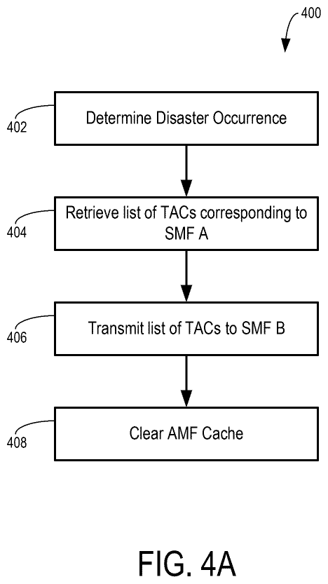

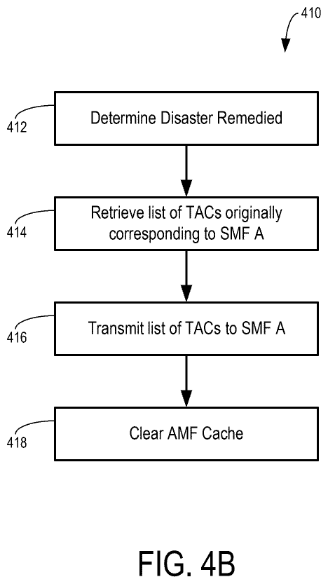

Accordingly, the rerouting control mechanism 304 is configured to implement a method for managing network function routing. FIG. 4A illustrates an example method 400. The method 400 may be implemented by a network management node, as will be discussed in more detail below. The network management node is an example of a computing device implementing the rerouting control mechanism 304 described above. The method 400 begins with operation 402 of determining that a first network node (e.g., a network node associated with a first SMF instance) has been rendered inoperable. Operation 402 may include detecting that a disaster case scenario has affected the first network node. This may be detected in a manual manner, an automated manner, or both. In an example of the manual detection, a network operator or technician may monitor outside information (e.g., newscasts, social media, technical support requests, etc.). In an example of the automated detection, a component of the network (e.g., the network management node) may monitor one or more connection metrics associated with the first network node. For example, the network component may monitor one or more key performance indicators (KPIs) associated with the first network node and, when a KPI or set of KPIs fall below one or more thresholds, the network component may detect that the first network node has been rendered inoperable. In either case, in response to a manual or automated detection that the first network node is inoperable, the network management node may receive an indication (e.g., from the network operator or technician, or from the network management node) that the first network node is inoperable. In response to the indication, the network management node may determine or detect that the first network node is inoperable.

When it has been determined that the first network node has been rendered inoperable, the method 400 proceeds to operation 404 of retrieving a list of TACs. The list of TACs may identify one or more network components, which may be a plurality of UEs or RAN components (e.g., gNBs), that were previously (e.g., prior to operation 402) allocated to receive services from the first network node via a second network node (e.g., from the first SMF instance via a network node associated with an AMF). The list of TACs may be received from any network node that is aware of which TACs were allocated to the first network node (e.g., the NRF). For example, the network management node may transmit a request to a network node requesting a list of the TACs that were allocated to the first network node, and the network node may respond to the request with the list of TACs. Then, at operation 406, the list of TACs is transmitted to a third network node (e.g., a network node associated with a second SMF instance). For example, the network management node may transmit the list of TACs to a network node associated with a second SMF instance.

At operation 408, the second network node clears its cache. Operation 408 may include transmitting a request from the network management node to the second network node. After clearing its cache, the second network node may be configured to transmit a query to a fourth network node (e.g., a network node associated with the NRF). The fourth network node may respond by instructing the second network node to associate with the third network node, for example to provide service to network components associated with the list of TACs that was retrieved and transmitted in operations 404 and 406. Thus, the telecommunications network implementing the method 400 may provide continued service to network components associated with the list of TACs (i.e., previously associated with the first SMF instance) even though the first SMF instance has failed.

FIG. 4B illustrates an example method 410 for reverting the method 400. In examples, the method 410 may be performed at some point after the method 400 when it is safe to revert the routing to its original configuration. The method 410 may be implemented by the same network management node as the method 400, and/or on a different network management node. The method 410 begins with an operation 412 of detecting that the first network node has been rendered operable. This may include detecting that any disaster case scenario that previously affected the first network node has been remedied, or may include detecting that a backup of the first network node has been implemented. As with operation 402, operation 412 may be detected in a manual manner, an automated manner, or both. In an example of the manual detection, a network operator or technician may monitor outside information (e.g., newscasts, social media, technical support requests, etc.). In an example of the automated detection, a component of the network (e.g., the network management node) may monitor one or more connection metrics associated with the first network node. For example, the network component may monitor one or more KPIs associated with the first network node and, when a KPI or set of KPIs rise above one or more thresholds, the network component may detect that the first network node has been rendered operable. In either case, in response to a manual or automated detection that the first network node is once again operable, the network management node may receive an indication (e.g., from the network operator or technician, or from the network management node) that the first network node is operable. In response to the indication, the network management node may determine or detect that the first network node is operable.

When it has been determined that the first network node has been rendered operable, the method 400 proceeds to operation 404 of retrieving a list of TACs identifying one or more network components that were initially (e.g., prior to operation 402) allocated to receive services from the first network node via the second network node. The list of TACs may be received from any network node that is aware of which TACs were originally allocated to the first network node (e.g., the NRF). Then, at operation 416, the list of TACs is transmitted to the first network node.

At operation 418, the second network node clears its cache. Operation 418 may be similar to or the same as operation 408, and may include transmitting a request from the network management node to the second network node. After clearing its cache, the second network node may be configured to transmit a query to the fourth network node. The fourth network node may respond by instructing the second network node to associate with the first network node. Thus, the telecommunications network implementing the method 410 may provide continued service to network components associated with the list of TACs (i.e., originally associated with the first SMF instance) even though the first SMF instance has failed and the failure has subsequently been remedied.

While FIGS. 4A and 4B illustrate the various operations being performed in a particular serial order, the present disclosure is not so limited. In some implementations, the operations may be performed in a serial order different from that illustrated in FIGS. 4A and 4B, and/or may be performed in parallel. In one particular example, after operation 402 or 412 has been performed, operations 404-408 or 414-418 may be performed substantially in parallel.

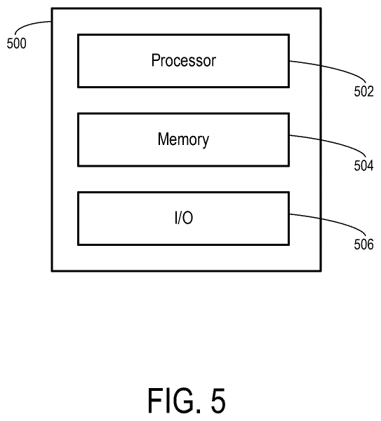

The method 400 and/or the method 410 may be implemented in the form of a script, and the script may be initiated in a manual or automated manner. In the manual implementation, the script may be initiated by a network operator or technician. In the automated implementation, the script may be automatically performed when it is determined that the first network node has been rendered inoperable (for the method 400) or operable (for the method 410). In either case, the script may cause the automatic performance of operations 404-408 or 414-418, as appropriate. The script may reside in a network management node, and implemented by a device or combination of devices operating in a telecommunications network. Thus, the script is one example of the rerouting control mechanism 304 of FIGS. 3A-3C. FIG. 5 illustrates one example of a network management node 500, which is itself an example of (or implements) the notification control mechanism 304 described above. The network management node 500 may be located at a site level (e.g., a network level, a geographic level, etc.) of the telecommunications network, and may control routing operations for one or more NFs in the network.

As illustrated, the network management node 500 comprises a processor 502, a memory 504, and an input/output (I/O) interface 506. The network management node 500 may be configured with various modules (e.g., various software modules) to implement network management functions, such as network repository functions. In some implementations, the network management node 500 may be configured to generate, control, and/or maintain virtual machines corresponding to the different network nodes. In other implementations, however, the network management node 500 itself may correspond to one of the above described network nodes (e.g., a network node associated with one or more NFs).

In one example, the modules may be present in the memory 504 in the form of instructions that, when executed by the processor 502, cause the network management node 500 to perform any one or more of the operations described herein. In another example, the processor 502 may be configured to load and/or execute instructions from another non-transitory computer-readable medium (e.g., cloud storage or from the memory of another device). In some examples, the following modules may be in the form of xApps and/or rApps (or portions or combinations thereof).

The network management node 500 may comprise a logic module configured to perform various determinations and other logical operations. For example, the logic module may be configured to determine whether a network node has been rendered operable and/or inoperable. The network management node 500 may comprise a data receipt module configured to receive various data (e.g., via the I/O interface 506). The received data may include a list of TACs as described above. The network management node 500 may comprise a data transmit module configured to transmit various data (e.g., via the I/O interface 506). The transmitted data may include the list of TACs as described above, and/or may include instructions to cause other network nodes to perform various operations including cache clearing.

The I/O interface 506 may include interface components to permit the communication of data to and from external devices or sources. For example, the I/O interface 506 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O interface 506 may additionally or alternatively include communication ports and/or interfaces to permit communication with a user. For example, the I/O interface 506 may include interfaces for a mouse, a keyboard, a display, a graphical user interface (GUI), buttons, switches, etc.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of managing network function routing in a telecommunications network, the method comprising:
determining that a first network node has been rendered inoperable, wherein the first network node is associated with a first Session Management Function (SMF);
retrieving a list of tracking area codes (TACs), the list of TACs corresponding to one or more network components serviced by the first network node via a second network node, wherein the second network node is associated with an Access and Mobility Management Function (AMF);
transmitting the list of TACs to a third network node, wherein the third network node is associated with a second SMF; and
causing the second network node to clear its cache.

2. The method of claim 1, wherein the operation of determining that the first network node has been rendered inoperable includes determining that a disaster case scenario has affected the first network node.

3. The method of claim 1, further comprising:
after the operation of causing the second network node to clear its cache:
receiving a query from the second network node at a fourth network node, wherein the fourth network node is associated with a Network Repository Function (NRF), and
instructing the second network node to associate with the third network node.

4. The method of claim 1, further comprising:
in response to the operation of determining that the first network node has been rendered inoperable, initiating a script, wherein the script is configured to automatically cause performance of the operations of retrieving the list of TACs, transmitting the list of TACs to the third network node, and causing the second network node to clear its cache.

5. The method of claim 4, wherein the operation of initiating the script is manually performed by a network operator.

6. The method of claim 4, further comprising:
automatically monitoring a connection metric associated with the first network node; and
in response to a determination that the connection metric indicates that the first network node has been rendered inoperable, automatically performing the operation of initiating the script.

7. The method of claim 1, wherein the first network node, the second network node, and the third network node are physically located within a same geographical region of the telecommunications network.

8. A telecommunications network comprising:
at least one processor in communication with a network management node; and
a memory storing instructions that, when executed by the at least one processor, cause the network management node to:
determine that a first network node has been rendered inoperable, wherein the first network node is associated with a first Session Management Function (SMF),
retrieve a list of tracking area codes (TACs), the list of TACs corresponding to one or more network components serviced by the first network node via a second network node, wherein the second network node is associated with an Access and Mobility Management Function (AMF),
transmit the list of TACs to a third network node, wherein the third network node is associated with a second SMF, and
cause the second network node to clear its cache.

9. The network of claim 8, wherein the operation of determining that the first network node has been rendered inoperable includes determining that a disaster case scenario has affected the first network node.

10. The network of claim 8, wherein the instructions, when executed by the at least one processor, further cause the network management node to:
after the operation of causing the second network node to clear its cache:
receive a query from the second network node at a fourth network node, wherein the fourth network node is associated with a Network Repository Function (NRF), and
instruct the second network node to associate with the third network node.

11. The network of claim 8, wherein the instructions, when executed by the at least one processor, further cause the network management node to:
in response to the operation of determining that the first network node has been rendered inoperable, initiate a script, wherein the script is configured to automatically cause performance of the operations of retrieving the list of TACs, transmitting the list of TACs to the third network node, and causing the second network node to clear its cache.

12. The network of claim 11, wherein the operation of initiating the script is manually performed by a network operator.

13. The network of claim 11, wherein the instructions, when executed by the at least one processor, further cause the network management node to:
automatically monitoring a connection metric associated with the first network node; and
in response to a determination that the connection metric indicates that the first network node has been rendered inoperable, automatically performing the operation of initiating the script.

14. The network of claim 8, wherein the first network node, the second network node, and the third network node are physically located within a same geographical region of the telecommunications network.

15. A non-transitory computer-readable medium storing instructions that, when executed by at least one processor of a network management node in a telecommunications network, cause the network management node to perform operations comprising:
determining that a first network node has been rendered inoperable, wherein the first network node is associated with a first Session Management Function (SMF);
retrieving a list of tracking area codes (TACs), the list of TACs corresponding to one or more network components serviced by the first network node via a second network node, wherein the second network node is associated with an Access and Mobility Management Function (AMF);
transmitting the list of TACs to a third network node, wherein the third network node is associated with a second SMF; and
causing the second network node to clear its cache.

16. The non-transitory computer-readable medium of claim 15, wherein the operation of determining that the first network node has been rendered inoperable includes determining that a disaster case scenario has affected the first network node.

17. The non-transitory computer-readable medium of claim 15, the operations further comprising:
after the operation of causing the second network node to clear its cache:
receiving a query from the second network node at a fourth network node, wherein the fourth network node is associated with a Network Repository Function (NRF), and
instructing the second network node to associate with the third network node.

18. The non-transitory computer-readable medium of claim 15, the operations further comprising:
in response to the operation of determining that the first network node has been rendered inoperable, initiating a script, wherein the script is configured to automatically cause performance of the operations of retrieving the list of TACs, transmitting the list of TACs to the third network node, and causing the second network node to clear its cache.

19. The non-transitory computer-readable medium of claim 18, the operations further comprising:
automatically monitoring a connection metric associated with the first network node; and
in response to a determination that the connection metric indicates that the first network node has been rendered inoperable, automatically performing the operation of initiating the script.

20. The non-transitory computer-readable medium of claim 15, wherein the first network node, the second network node, and the third network node are physically located within a same geographical region of the telecommunications network.
